(19) United States
(12) Patent Application Publication
(10) Pub. No.: US 2003/0093875 A1
(43) Pub. Date: May 22, 2003

(54) Clamping edge rail for frameless glass panel

(76) Inventor: Konstantinos Stefanidis, Athens (GR)

Correspondence Address: Stavros Dimas, Attorney at Law, 7 Xanthou Str, Athens, 106 73, GR

(21) Appl. No.: 10/049,768

(22) PCT Filed: Dec. 21, 2000
(86) PCT No.: PCT/GR00/00042

(30) Foreign Application Priority Data
Dec. 22, 1999 (GR) 990100443

(51) Int. Cl. A47H 1/04; E05D 15/00

(52) U.S. Cl. 16/96 R

(57) ABSTRACT

The method of clamping glass panels of high density without frame (and without notches or cuts in the glass) by the use of specially designed aluminum profiles.

The method refers to the process of clamping glass panel on high density for the production of multiple types of glass doors and partitions.

The method is based on the use of “mirror” aluminum profiles (1) in combination with an inner connection unit (2), side screw covers (3), forward and rear end covers (11), plastic washer (12) and side screw (13), allowing clamping of glass panel with cutting or drilling of glass and without frame. The same profiles can be used for clamping either top and or base of glass panel. Also purpose made accessories, (pivot, hanger, bracket) can be assembled without any kind of intervention on the profiles or the glass, enabling production of various forms of finished product, (e.g. Stable glass panel swing, sliding, revolving glass doors, folding glass sliding wall systems—harmonica type partitions etc). the addition of decorative side covers (4) offers more potential in the choice of final esthetic result. Finally the product can be shaped according to the requirements.

The invention involves the process of clamping Glass Panels without frame using aluminum profiles, for use in the manufacture of stable, swing or sliding glass panels for both interior or exterior construction.

The available processes of clamping glass panels require the construction of a frame of aluminum or other material, with the intention of placing the glass panels in this. In this way the construction cost increases and the esthetic result is reduced.

It is also a fact that there are already products that make the construction of the frame unnecessary. In this case, however, it is necessary to drill or cut the glass itself in order to clamp the panel. Also several differing profiles and accessories are needed in order to clamp both the top and the base of the glass panel, plus various profiles for use with swing, sliding, revolving, harmonica, or glass sliding shop—front systems type uses.

Our new invention is based on the use of “mirror” aluminum profile, which in combination with a plastic washer, inner connection unit, tightening screws, side screw covers, plus forward and rear and covers, allows clamping of glass panels without cutting or drilling of glass. In combination with the use of proper fitting, and without mechanical intervention, slides into the specially designed inner rail, of the profile making it possible for the final product to be shaped to any desirable form, stable, swing, revolving, folding, sliding, harmonica etc. With the use of ready made accessories (roller, pivot, bracket etc.). The addition of decorative side covers offers more potential in the choice of final esthetic result. This specially designed profile can also be used with curved or circular glass panels e.g., revolving doors.

The use of “mirror” profiles, which clamp the glass panels with mechanical tightening, makes conventional frame redundant. Thus, the construction cost is reduced, giving more capabilities of variation on the esthetic result. An important advantage of the invention is represented by the way the glass panel is clamped making drilling or cutting unnecessary, as well as the use of the same “mirror” profiles for the clamping of both top and base, in whatever kind of use.

Special attachments are available which can be fitted and positioned at various points on the inner rail of the profile according to the requirements of the fitter, ensuring high quality and total stability and reliability.

Decorative side covers, specially shaped (out of stainless steel, bronze, aluminum power coated, or other material) can simply be fastened on the side of the “mirror” profiles (clamp profile) and give multiple visual results according to requirements. The placement of the above decorative side covers is accompanied by the replacement of the forward and rear end covers of the profiles by others, which are made out of the same material.

What is more, the capability of the profiles to undergo the procedure of creating curves offers more potential for multiple use.

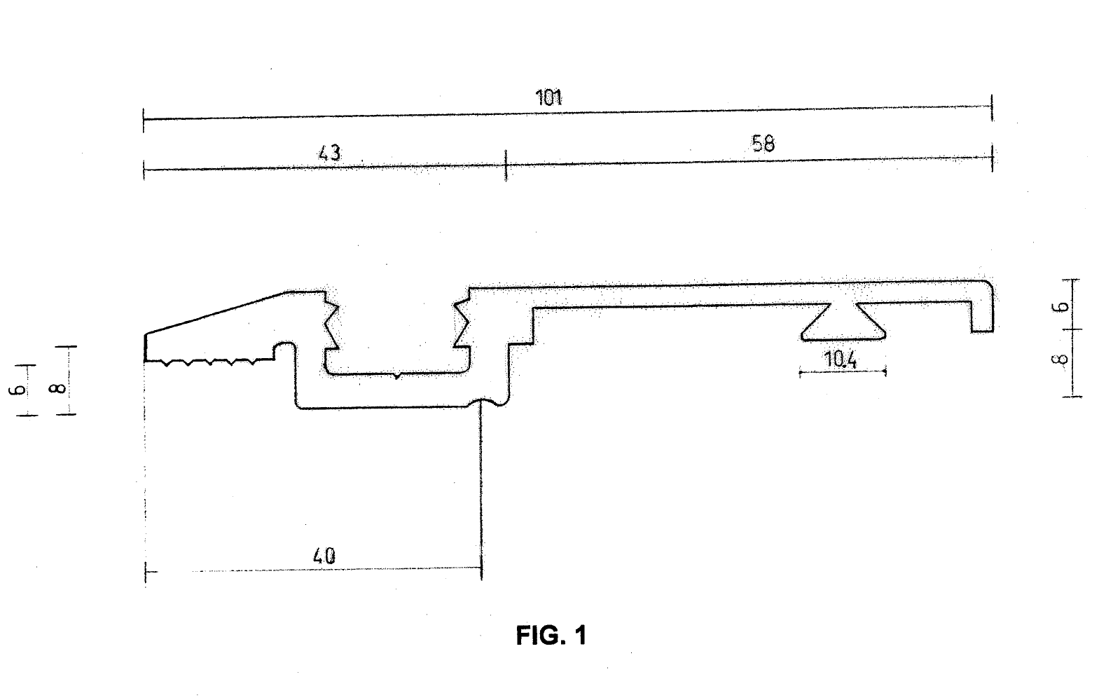

FIG. 1 shows the clamp profile (1),

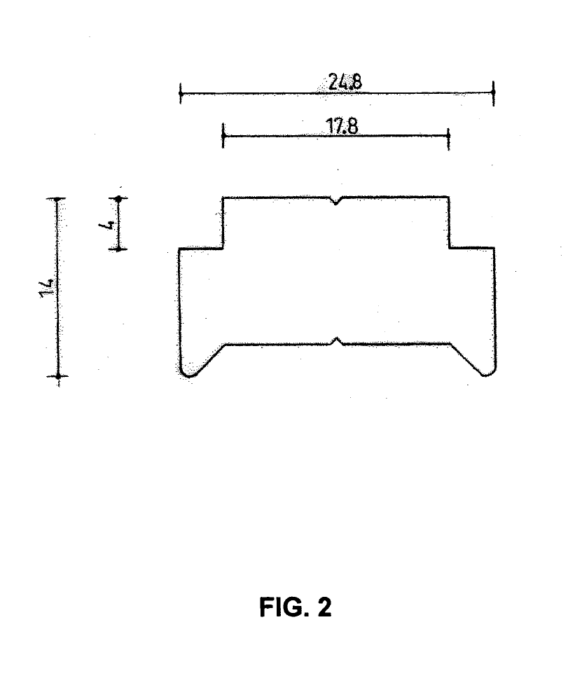

FIG. 2 the inner connection unit (2) (the dimension can be altered to the density of clamp various thicknesses of glass),

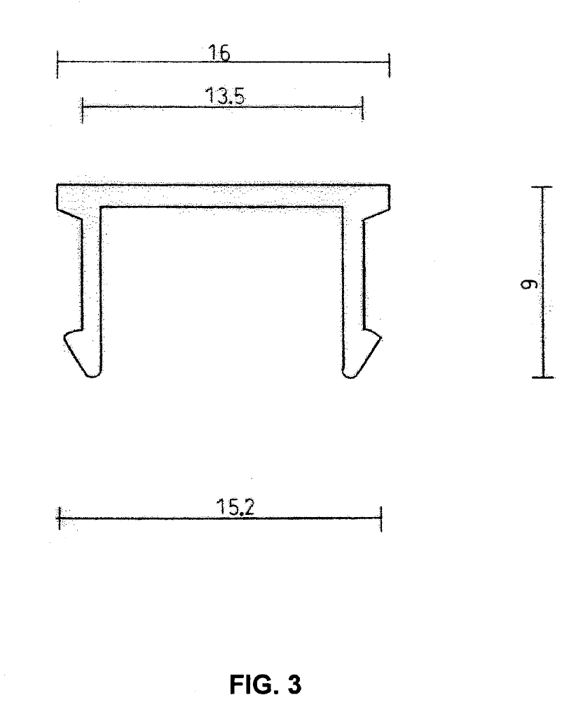

FIG. 3 the side screw cover (3) and,

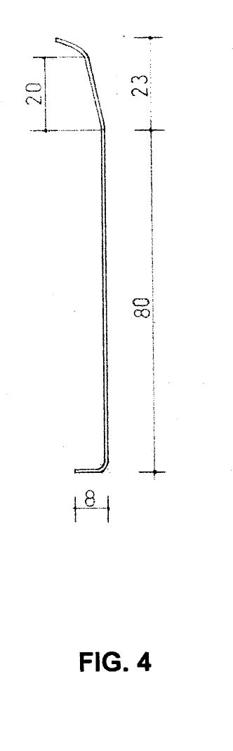

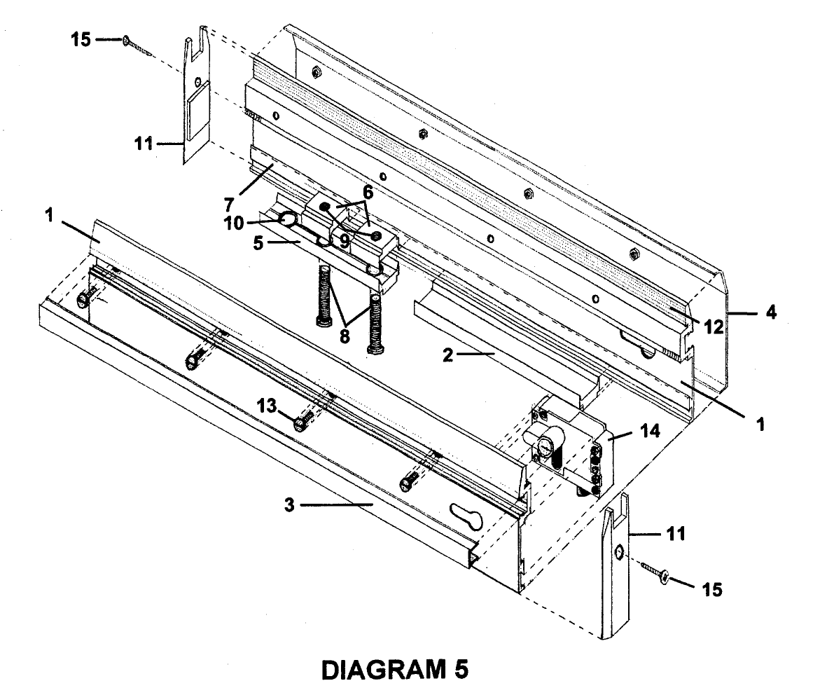

FIG. 4 shows the decorative side covers (4), diagr. 5 represents a complete picture regarding the assembly of all basic and supplementary parts of a swing glass door top unit with overhead pin lock (top swing glass door rail with lock).

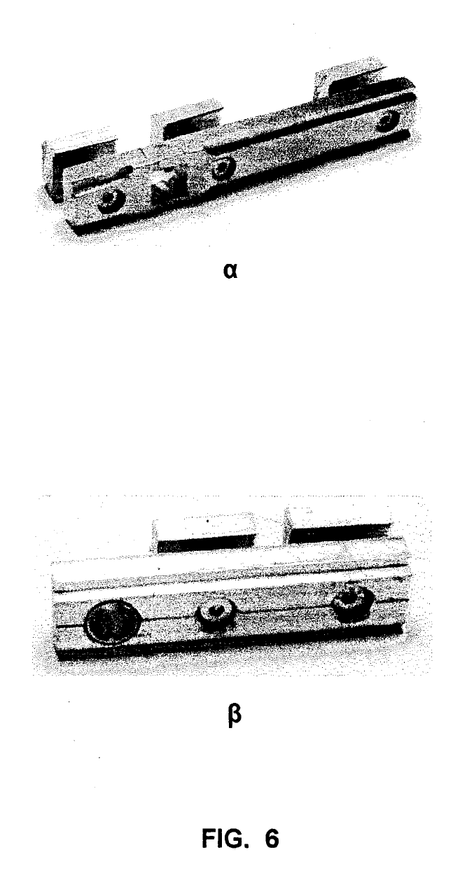

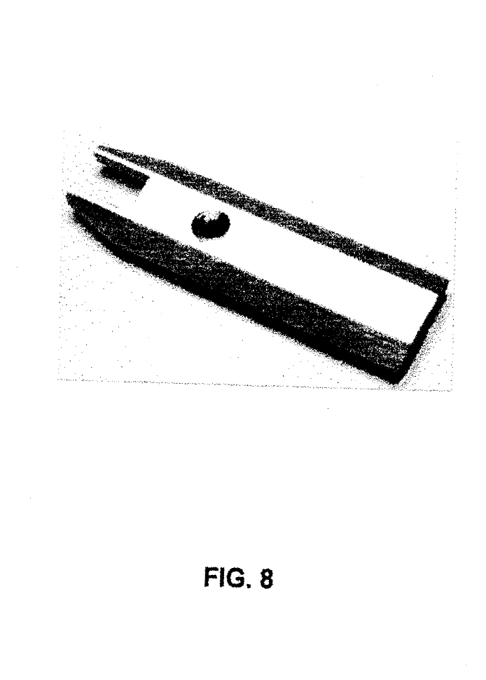

To assemble one swing glass door base unit (base swing glass door rail) take two “mirror” clamp profiles as in FIG. 1 and connect the two parts by inserting the inner connector unit FIG. 2. Slide in one “bracket” FIG. 6a, screw together, cover the screw with “side screw covers” as in FIG. 3 and finally place the forward and rear end covers FIG. 8.

To assemble one swing glass door top unit (top swing glass door rail) take two “mirror” damp profiles as in FIG. 1 and connect the two parts by inserting the “inner connector unit” FIG. 2, slide in one “pivot” FIG. 6b, screw together. Cover the screws with “side screw covers” as in FIG. 3 and finally place the forward and rear end covers FIG. 8. To secure the glass door, various locking mechanisms can be placed into the units (top and or base rails). a) Pin lock diagr.5 (14), b) Side latch, c) electric catch or d) electromagnetic lock.

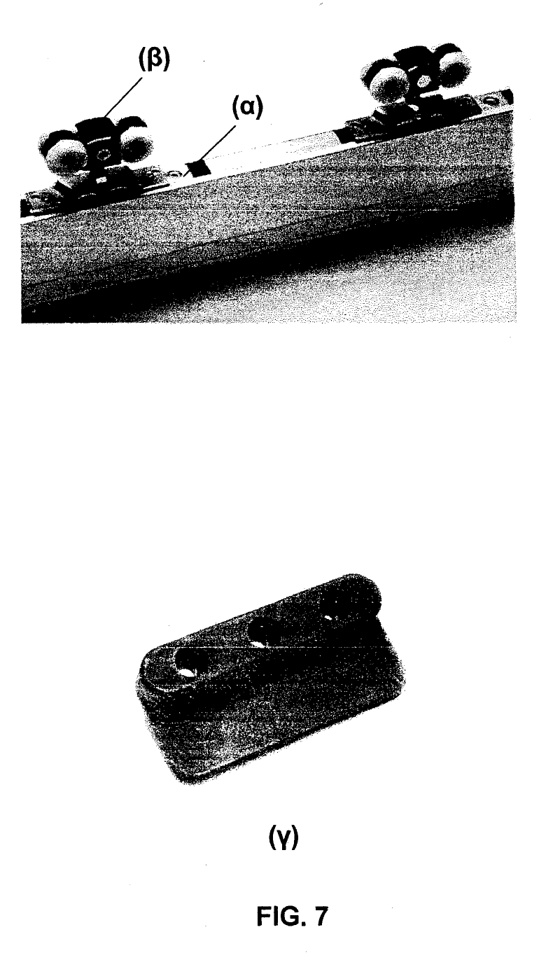

To assemble one sliding glass door top unit (glass sliding top rail) take two “mirror” clamp profiles as in FIG. 1 and connect the two parts by inserting two “inner connectors—hanger” units FIG. 7a. Assemble two rollers FIG. 7b, screw together, cover the screw with “side screw covers” as in FIG. 3 and “finally place the forward and rear end covers FIG. 8.

To assemble one sliding glass door base unit (glass sliding base rail) take two “mirror” clamp profiles as in FIG. 1 connect and screw together the parts by inserting the “inner connector” unit FIG. 2 and finally place the forward and rear end covers FIG. 8. To secure the glass sliding door you can assemble a pin lock diagr.5 (14) on the one side of the unit. To keep the glass panel vertical during sliding it should be used in combination with “floor side guide” FIG. 7y.

To assemble one fixed glass panel rail unit, take two “mirror” clamp profiles as in FIG. 1 connect and screw together by using a fixed rail profile which is screwed into the floor. The clamp profile unit slides into the fixed rail profile through the special inner rail of the clamp profile diagr.5 (7), finally place the forward end cover, FIG. 8.

The ability of the “mirror” clamp profile to be curved offers us the following units:

a) Curved top and base swing glass door units (rails)

b) Curved top and base sliding glass door units (rails)

c) Curved top and base fixed glass panels

d) Revolving glass doors (in combination with special connectors and turnstile.

To assemble one glass sliding wall panel, or a folding sliding glass wall system (for example harmonica type glass door) you take 2 “mirror” clamp profiles as in FIG. 1 and connect the two parts by inserting two “inner connectors—hanger” units FIG. 7a. Assemble two special rollers designed for use with overhead rail, screw together, cover the screw with “side screw covers” as in FIG. 3 and finally install a pin end cover on one end and a slot end cover on the other.

Decorative side covers FIG. 4 can be used on all types of clamp, in any type of installation.

The basic principle of this invention is based on the ability of the pivot unit FIG. 6b or other accessories e.g.. Bracket unit FIG. 6a or inner hanger FIG. 7a, to be slid accurately into position on the inner rails, diagr.5 (7) of the clamp profile and secured according to the requirements of the fitter. In diagram 5 the basic assembly of a top swing glass door rail is described as follows:

The main parts of the invention are the “mirror” clamp profiles (1) and the inner connection unit (2). The base of the pivot (5), which fits to the underside of the inner rail (7), is screwed (8) to the upper parts (6), which fit to the upper side of the inner rail (7) and are secured. The base of the pivot (5) also includes the slot (10) into which the glass panel is hinged. In diagram 5 we can also see how to position a pin lock (14), the forward and rear end covers (11) by means of screw (15). The clamp is tightened and glass panel fixed securely and safely into position by plastic washer (12) by tightening side screw (13) which are then covered by side screw cover (3).

1. Method of clamping glass panels of high density without frame (and without notches or cuts in the glass) by the use of specially designed aluminum profiles. Characterized by the use of 1 set of mirror clamp profiles (1), inner connection unit (2), side screw covers (3), forward and rear end covers (11), plastic washer (12), and side screws (13).

2. Method of clamping glass panel of high density without frame according to claim 1, characterized by the ability for immediate assembly, without any kind of intervention on the mirror clamp profile (1). Purpose made accessories to fit on inner rail, diagr.5 (7), of clamp profile enabling production of various forms of finished product.

3. Method of clamping glass panel of high density without frame according to claims 1 &2 characterized by the ability for immediate assembly, without any kind of intervention, decorative side covers FIG. 4 of various materials (aluminum, stainless steel etc.) give multiple visual results for esthetic purposes, diag.4.

4. Methods of clamping glass panel of high density without frame according to claims 1, 2, & 3, characterized by the ability of the mirror clamp profiles (1) to be curved and shaped.
